(19) United States
(12) Patent Application Publication
(10) Pub. No.: US 2023/0089004 A1
(43) Pub. Date: Mar. 23, 2023

(54) DISPLAY DEVICE AND DRIVING METHOD THEREFOR AND MANUFACTURING METHOD THEREOF

(71) Applicants: Hefei BOE Optoelectronics Technology Co., Ltd., Hefei, Anhui (CN); BOE Technology Group Co., Ltd., Beijing (CN)

(72) Inventors: Yanni LIU, Beijing (CN); Hui WANG, Beijing (CN); Shengguang WANG, Beijing (CN); Huijuan YU, Beijing (CN); Jinming ZHU, Beijing (CN); Xin YI, Beijing (CN)

(21) Appl. No.: 17/761,986

(22) PCT Filed: May 12, 2021
(86) PCT No.: PCT/CN2021/093330

§ 371 Date: Mar. 18, 2022

(30) Foreign Application Priority Data
Jun. 11, 2020 (CN) 202010530166.X

(51) Int. Cl. G02F 1/1335; G02F 1/1337; G09G 3/36

(52) U.S. Cl. CPC G02F 1/133536; G02F 1/133504; G02F 1/133512; G02F 1/1337; G09G 3/3607

(57) ABSTRACT

A display device and a driving method therefor and a manufacturing method thereof. The display device includes: a liquid crystal cell (1); a first polarizer (2) positioned at a light incident side of the liquid crystal cell (1); and a reflective polarization structure (3) positioned at one side of the liquid crystal cell (1) away from the first polarizer (2). The reflective polarization structure (3) is configured to absorb light having a polarization direction parallel to a transmission axis direction of the first polarizer (2), and to reflect light having a polarization direction perpendicular to the transmission axis direction of the first polarizer (2).

### CROSS REFERENCE TO RELATED APPLICATION

The present application claims the priority of Chinese Patent Application No. 202010530166.X, filed to the Chinese Patent Office on Jun. 11, 2020 and entitled “DISPLAY DEVICE AND DRIVING METHOD THEREFOR AND MANUFACTURING METHOD THEREOF”, which is incorporated in its entirety herein by reference.

### FIELD

The present disclosure relates to the technical field of display, and in particular to a display device and a driving method therefor and a manufacturing method thereof.

### BACKGROUND

Reflective liquid crystal display products have huge market potential due to low power consumption, high aperture ratio and no backlight.

Reflective liquid crystal display products display frames by reflecting ambient light or light emitted by light sources outside displays. To realize reflective display, it is necessary to arrange a half-wave plate and a quarter-wave plate between an upper polarizer and a color film substrate. However, at a low gray scale, reflectivity of the half-wave plate and reflectivity of the quarter-wave plate vary greatly with a voltage, resulting in low contrast of a display frames and serious light leakage.

### SUMMARY

An embodiment of the present disclosure provides a display device. The display device includes:

a liquid crystal cell;

a first polarizer arranged at a light incident side of the liquid crystal cell; and

a reflective polarization structure arranged at one side, away from the first polarizer, of the liquid crystal cell; where the reflective polarization structure is configured to absorb light having a polarization direction parallel to a direction of a transmission axis of the first polarizer, and to reflect light having a polarization direction perpendicular to the direction of the transmission axis of the first polarizer.

Optionally, in the embodiment of the present disclosure, the reflective polarization structure includes:

a reflective light brightness enhance film, where a transmission axis of the reflective light brightness enhance film is parallel to the transmission axis of the first polarizer, and a reflection axis of the reflective light brightness enhance film is perpendicular to the transmission axis of the first polarizer; and

a light absorption layer arranged at one side, away from the liquid crystal cell, of the reflective light brightness enhance film.

Optionally, in the embodiment of the present disclosure, the reflective polarization structure includes:

a polarization apparatus including a plurality of stacked wave plates, where a transmission axis of the polarization apparatus is parallel to the transmission axis of the first polarizer, and a reflection axis of the polarization apparatus is perpendicular to the transmission axis of the first polarizer; and

a light absorption layer arranged at one side, away from the liquid crystal cell, of the polarization apparatus.

Optionally, in the embodiment of the present disclosure, the reflective polarization structure includes:

a second polarizer, where a transmission axis of the second polarizer is perpendicular to the transmission axis of the first polarizer; and

a reflective layer arranged at one side, away from the liquid crystal cell, of the second polarizer.

Optionally, in the embodiment of the present disclosure, the display device further includes:

an antireflective layer arranged between the reflective polarization structure and the liquid crystal cell.

Optionally, in the embodiment of the present disclosure, the display device further includes:

a protective layer arranged at one side, away from the liquid crystal cell, of the reflective polarization structure.

Optionally, in the embodiment of the present disclosure, the display device further includes:

a scattering layer arranged between the first polarizer and the liquid crystal cell.

Optionally, in the embodiment of the present disclosure, the liquid crystal cell includes:

a liquid crystal layer;

an opposite substrate arranged at one side, facing the first polarizer, of the liquid crystal layer; where the opposite substrate includes: a first alignment layer adjacent to the liquid crystal layer, and a rubbing alignment direction of the first alignment layer is parallel to the transmission axis of the first polarizer; and

an array substrate arranged at one side, facing the reflective polarization structure, of the liquid crystal layer; where the array substrate includes: a second alignment layer adjacent to the liquid crystal layer, and a rubbing alignment direction of the second alignment layer is perpendicular to the transmission axis of the first polarizer.

Optionally, in the embodiment of the present disclosure, the liquid crystal cell includes:

a liquid crystal layer;

an opposite substrate arranged at one side, facing the first polarizer, of the liquid crystal layer; where the opposite substrate includes: a first alignment layer adjacent to the liquid crystal layer, and a rubbing alignment direction of the first alignment layer is parallel to the transmission axis of the first polarizer; and

an array substrate arranged at one side, facing the reflective polarization structure, of the liquid crystal layer, where the array substrate includes: a second alignment layer adjacent to the liquid crystal layer, and a rubbing alignment direction of the second alignment layer is parallel to the transmission axis of the first polarizer.

Accordingly, an embodiment of the present disclosure further provides a driving method for a display device. The driving method includes:

controlling a liquid crystal in a liquid crystal cell to be in a first state to change a polarization state of light passing through a first polarizer after the light passes through the liquid crystal cell, then reflecting the light by a reflective polarization structure, changing the polarization state of reflected light again after the reflected light passes through the liquid crystal cell, and emitting the reflected light from the first polarizer, to realize bright-state display;

controlling the liquid crystal in the liquid crystal cell to be in a second state to change a polarization state of light passing through the first polarizer after the light passes through the liquid crystal cell, and then absorbing the light by the reflective polarization structure, to realize dark-state display; and

controlling the liquid crystal in the liquid crystal cell to be in a third state to change a polarization state of part of light passing through the first polarizer and unchange a polarization state of the remaining part of light after the light passes through the liquid crystal cell, then absorbing the part of light by the reflective polarization structure, and reflecting the remaining part of light by the reflective polarization structure, changing the polarization state of reflected light again after the reflected light passes through the liquid crystal cell, and emitting the reflected light from the first polarizer, to realize gray scale display between the bright-state display and the dark-state display.

Optionally, in the embodiment of the present disclosure, a rubbing alignment direction of a first alignment layer is parallel to the transmission axis of the first polarizer, a rubbing alignment direction of a second alignment layer is perpendicular to the transmission axis of the first polarizer; where the controlling the liquid crystal in the liquid crystal cell to be in the first state specifically includes: applying no voltage to the liquid crystal cell, and controlling the liquid crystal in the liquid crystal cell to be in an initial alignment state;

the controlling the liquid crystal in the liquid crystal cell to be in the second state specifically includes: applying a bright-state voltage to the liquid crystal cell, and controlling the liquid crystal in the liquid crystal cell to deflect to the second state; and

the controlling the liquid crystal in the liquid crystal cell to be in the third state specifically includes: applying a preset voltage corresponding to a gray-scale value to the liquid crystal cell, and controlling the liquid crystal in the liquid crystal cell to deflect to the third state.

Optionally, in the embodiment of the present disclosure, a rubbing alignment direction of a first alignment layer is parallel to the transmission axis of the first polarizer, and a rubbing alignment direction of a second alignment layer is parallel to the transmission axis of the first polarizer; where the controlling the liquid crystal in the liquid crystal cell to be in the first state specifically includes: applying a dark-state voltage to the liquid crystal cell, and controlling the liquid crystal in the liquid crystal cell to deflect to the first state;

the controlling the liquid crystal in the liquid crystal cell to be in the second state specifically includes: applying no voltage to the liquid crystal cell, and controlling the liquid crystal in the liquid crystal cell to deflect to an initial alignment state; and

the controlling the liquid crystal in the liquid crystal cell to be in the third state specifically includes: applying a preset voltage corresponding to a gray-scale value to the liquid crystal cell, and controlling the liquid crystal in the liquid crystal cell to deflect to the third state.

Accordingly, an embodiment of the present disclosure further provides a manufacturing method of a display device. The manufacturing method includes:

providing a liquid crystal cell;

forming a first polarizer at a light incident side of a liquid crystal; and

forming a reflective polarization structure at one side, away from the first polarizer, of the liquid crystal cell.

Optionally, in the embodiment of the present disclosure, the forming the reflective polarization structure at one side, away from the first polarizer, of the liquid crystal cell specifically includes:

forming a reflective light brightness enhance film at an entire face of one side, away from the first polarizer, of the liquid crystal cell; and

forming a light absorption layer at an entire face of one side, away from the liquid crystal cell, of the reflective light brightness enhance film.

Optionally, in the embodiment of the present disclosure, the forming the reflective polarization structure at one side, away from the first polarizer, of the liquid crystal cell specifically includes:

forming a polarization apparatus at an entire face of one side, away from the first polarizer, of the liquid crystal cell; and

forming a light absorption layer at an entire face of one side, away from the liquid crystal cell, of the polarization apparatus.

Optionally, in the embodiment of the present disclosure, the forming the reflective polarization structure at one side, away from the first polarizer, of the liquid crystal cell specifically includes:

forming a second polarizer at an entire face of one side, away from the first polarizer, of the liquid crystal cell; and

forming a reflective layer at an entire face of one side, away from the liquid crystal cell, of the second polarizer.

Optionally, in the embodiment of the present disclosure, the manufacturing method further includes:

forming a protective layer at one side, away from the liquid crystal cell, of the reflective polarization structure.

Optionally, in the embodiment of the present disclosure, the manufacturing method further includes:

forming an antireflective layer between the reflective polarization structure and the liquid crystal.

### BRIEF DESCRIPTION OF THE DRAWINGS

FIG. 1 is a structural schematic diagram of a display device provided in an embodiment of the present disclosure.

FIG. 2 is a structural schematic diagram of another display device provided in an embodiment of the present disclosure.

FIG. 3 is a schematic structural diagram of a reflective light brightness enhance film in a display device provided in an embodiment of the present invention.

FIG. 4 is a structural schematic diagram of yet another display device provided in an embodiment of the present disclosure.

FIG. 5 is a structural schematic diagram of a polarization apparatus in a display device provided in an embodiment of the present disclosure.

FIG. 6 is a structural schematic diagram of yet another display device provided in an embodiment of the present disclosure.

FIG. 7 is a structural schematic diagram of yet another display device provided in an embodiment of the present disclosure.

FIG. 8 is a structural schematic diagram of yet another display device provided in an embodiment of the present disclosure.

FIG. 9 is a structural schematic diagram of yet another display device provided in an embodiment of the present disclosure.

FIG. 10 is a structural schematic diagram of yet another display device provided in an embodiment of the present disclosure.

FIG. 11 is a structural schematic diagram of yet another display device provided in an embodiment of the present disclosure.

FIG. 12 is a structural schematic diagram of yet another display device provided in an embodiment of the present disclosure.

FIG. 13 is a structural schematic diagram of yet another display device provided in an embodiment of the present disclosure.

FIG. 14 is a structural schematic diagram of yet another display device provided in an embodiment of the present disclosure.

FIG. 15 is a structural schematic diagram of yet another display device provided in an embodiment of the present disclosure.

FIG. 16 is a simulation result diagram of voltage-reflectivity of display device a and display device b provided in embodiments of the present disclosure.

FIG. 17 is a simulation result diagram of voltage-reflectivity of different visual angles of the display device a provided in the embodiment of the present disclosure.

FIG. 18 is a simulation result diagram of voltage-reflectivity of different visual angles of the display device b provided in the embodiment of the present disclosure.

FIG. 19 is a simulation result diagram of attenuation of visual angles of the display device a and the display device b provided in the embodiments of the present disclosure.

FIG. 20 is a schematic diagram of a driving method for a display device provided in an embodiment of the present disclosure.

FIG. 21 is a schematic diagram of a manufacturing method of a display device provided in an embodiment of the present disclosure.

### DETAILED DESCRIPTION OF THE EMBODIMENTS

The specific implementation of a display panel and a manufacturing method thereof and a display device provided in embodiments of the present disclosure is described in detail below in conjunction with the accompanying drawings. A thickness and a shape of each film layer in the drawings do not reflect a true scale, but only for illustrating the present disclosure.

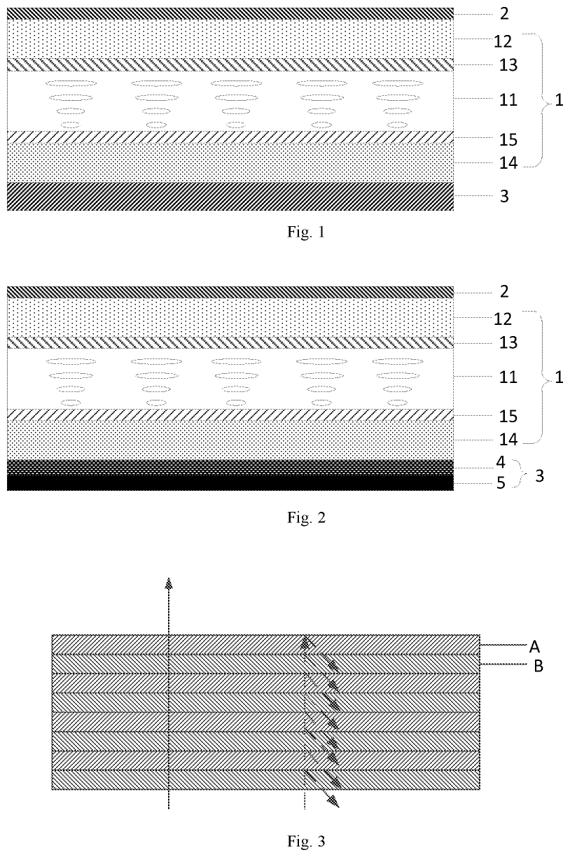

An embodiment of the present disclosure provides a display device. As shown in FIG. 1, the display device includes:

a liquid crystal cell 1;

a first polarizer 2 arranged at a light incident side of the liquid crystal cell 1; and

a reflective polarization structure 3 arranged at one side, away from the first polarizer 2, of the liquid crystal cell 1; where the reflective polarization structure 3 is configured to absorb light having a polarization direction parallel to a direction of a transmission axis of the first polarizer 2, and to reflect light having a polarization direction perpendicular to the direction of the transmission axis of the first polarizer 2.

In actual application, the display device provided in the embodiment of the present application is a liquid crystal display device, which may be applied to a reflective liquid crystal display.

According to the display device provided in the embodiment of the present disclosure, one side, away from the first polarizer, of the liquid crystal cell is provided with the reflective polarization structure; the reflective polarization structure may absorb the light having the polarization direction parallel to the direction of the transmission axis of the first polarizer, and reflect the light having the polarization direction perpendicular to the direction of the transmission axis of the first polarizer; and further a state of a liquid crystal in the liquid crystal cell is changed to change phase difference of light, so that the light is absorbed or reflected by the reflective polarization structure. Without arranging a half-wave plate and a quarter-wave plate between the liquid crystal cell and the first polarizer to change the phase difference, a reflective display function may be realized, contrast of a display frame may be improved, light leakage in a low gray scale may be avoided, a display effect may be improved, and user experience may be enhanced.

During specific implementation, the reflective polarization structure may be arranged in the following modes.

Mode 1: as shown in FIG. 2, in the display device provided in the embodiment of the present disclosure, the reflective polarization structure 3 includes:

a reflective light brightness enhance film 4, where a transmission axis of the reflective light brightness enhance film 4 is parallel to a transmission axis of the first polarizer 2, and a reflection axis of the reflective light brightness enhance film 4 is perpendicular to the transmission axis of the first polarizer 2; and

a light absorption layer 5 arranged at one side, away from the liquid crystal cell 1, of the reflective light brightness enhance film 4.

During specific implementation, for example, the reflective light brightness enhance film may be an advanced polarizer film (APF), or a dual brightness enhance film (DBEF).

During specific implementation, as shown in FIG. 3, in the display device provided in the embodiment of the present disclosure, the reflective light brightness enhance film 4 includes polymer film A and polymer film B which are alternatively stacked. Refractive indexes of the polymer film A and the polymer film B are different. When a beam of non-polarized light is incident, linearly polarized light in one direction is totally reflected back, and linearly polarized light in another direction passes. In this way, when a polarization direction of linearly polarized light passing through the liquid crystal cell is parallel to the reflection axis of the reflective light brightness enhance film, the light is reflected by the reflective light brightness enhance film, and when the polarization direction of the linearly polarized light passing through the liquid crystal cell is parallel to the transmission axis of the reflective light brightness enhance film, the light passes through the reflective light brightness enhance film and reaches the light absorption layer to be absorbed.

It should be noted that in FIG. 3, only a reflective light brightness enhance film formed by alternately stacking three layers of polymer films A and polymer films B is illustrated as an example, which is for clearly illustrating a structure of the reflective light brightness enhance film instead of limiting the number of polymer films A and the number of polymer films B. In actual application, the number of polymer films A and the number of polymer films B may be set according to actual needs, for example, a reflective light brightness enhance film including hundreds of layers of polymer films A and polymer films B which are alternately arranged may be manufactured through extrusion forming within a thickness of 100 μm.

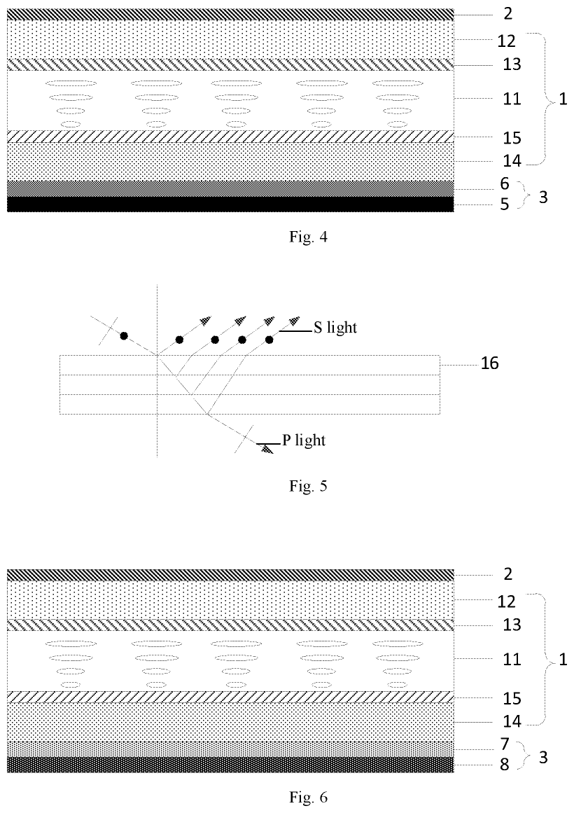

Mode 2: as shown in FIG. 4, in the display device provided in the embodiment of the present disclosure, the reflective polarization structure 3 includes:

a polarization apparatus 6 including a plurality of stacked wave plates 16 as shown in FIG. 5, where a transmission axis of the polarization apparatus 6 is parallel to a transmission axis of the first polarizer 2, and a reflection axis of the polarization apparatus 6 is perpendicular to the transmission axis of the first polarizer 2; and

a light absorption layer 5 arranged at one side, away from the liquid crystal cell 1, of the polarization apparatus 6.

It should be noted that a wave plate may be, for example, a thin glass sheet, that is, the polarization apparatus is formed by overlapping several thin glass sheets. As shown in FIG. 5, when natural light is incident on the wave plate stack, the light is continuously reflected and refracted by upper and lower surfaces of the wave plates 16, and finally transmitted light is mainly P light and reflected light is mainly S light, so as to separate light in different polarization directions. In this way, when a polarization direction of linearly polarized light passing through the liquid crystal cell is parallel to the reflection axis of the polarization apparatus, the light is reflected by the polarization apparatus; and when the polarization direction of the linearly polarized light passing through the liquid crystal cell is parallel to the transmission axis of the polarization apparatus, the light passes through the polarization apparatus and reaches the light absorption layer to be absorbed.

It should be noted that in FIG. 5, only a polarization apparatus formed by stacking three wave plates 16 is illustrated as an example, which is for clearly illustrating a structure of the polarization apparatus instead of limiting the number of wave plates 16. In actual application, the number of wave plates may be set according to actual needs.

During specific implementation, for example, the material of light absorption layers in Mode 1 and Mode 2 may include the blackbody material.

Mode 3: as shown in FIG. 6, in the display device provided in the embodiment of the present disclosure, the reflective polarization structure 3 includes:

a second polarizer 7, where a transmission axis of the second polarizer 7 is perpendicular to a transmission axis of the first polarizer 2; and

a reflective layer 8 arranged at one side, away from the liquid crystal cell 1, of the second polarizer 7.

In this way, when a polarization direction of linearly polarized light passing through the liquid crystal cell is perpendicular to the transmission axis of the second polarizer, the light is absorbed by the second polarizer; and when the polarization direction of the linearly polarized light passing through the liquid crystal cell is parallel to the transmission axis of the second polarizer, the light passes through the second polarizer and reaches the reflective layer to be reflected.

Optionally, for example, the material of the reflective layer may include a mirror reflection material.

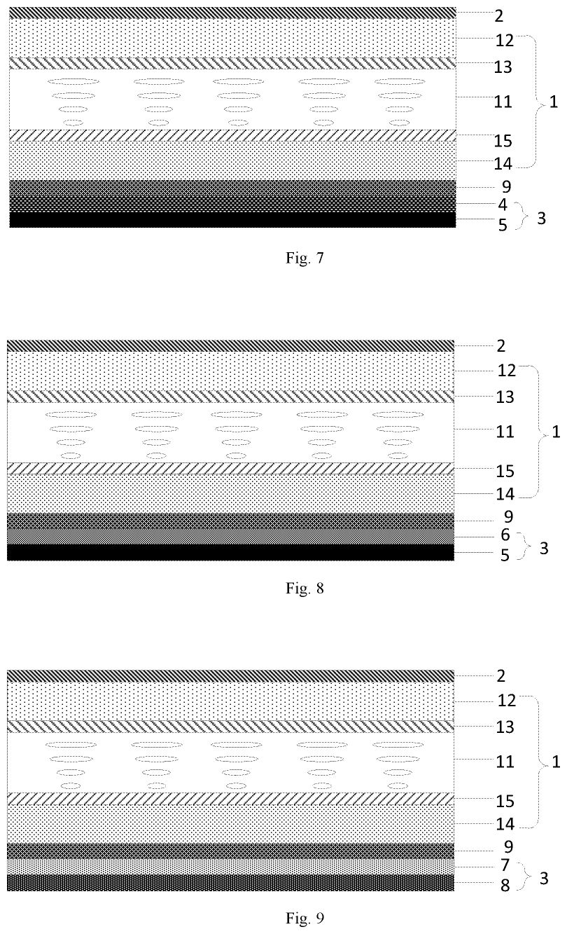

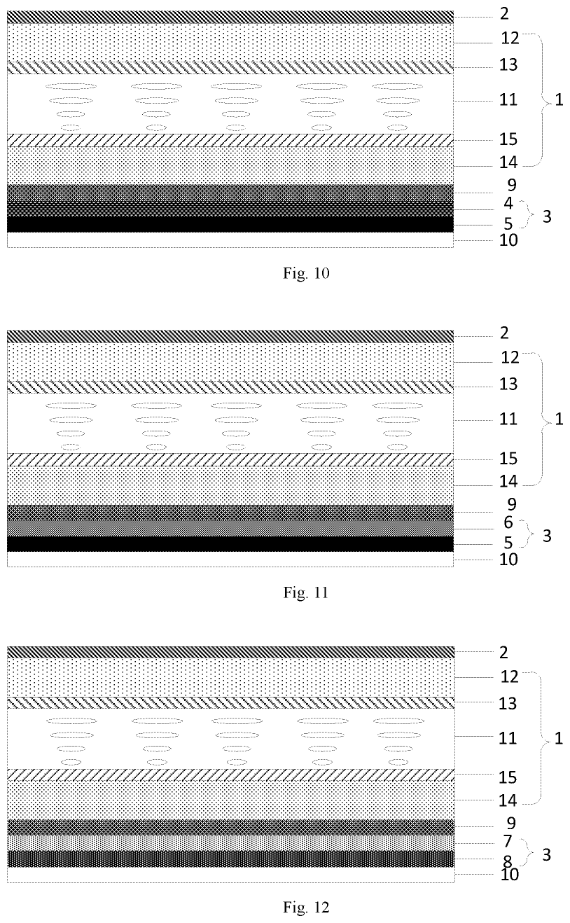

During specific implementation, as shown in FIGS. 7-9, the display device provided in the embodiment of the present disclosure further includes:

an antireflective layer 9 arranged between the reflective polarization structure 3 and the liquid crystal cell 1.

During specific implementation, the antireflective layer may be formed by stacking single-layer or multi-layer optical films having different refractive indexes, and a refractive index of the antireflective layer is low, so that mirror reflection of an interface at a light incident side of the reflective polarization structure may be reduced, and the light use efficiency may be improved.

During specific implementation, for example, a thickness of the antireflective layer may be ranged from dozens of nanometers to hundreds of nanometers.

Optionally, the material of the antireflective layer may include a transparent material having a low refractive index. The transparent material may be an inorganic material, such as silicon dioxide, magnesium fluoride and calcium fluoride. The transparent material also may be an organic material, such as organic silicon resin, amorphous fluororesin and so on.

During specific implementation, as shown in FIGS. 10-12, the display device provided in the embodiment of the present disclosure further includes:

a protective layer 10 arranged at one side, away from the liquid crystal cell 1, of the reflective polarization structure 3.

In the display panel provided in the embodiment of the present disclosure, the protective layer is formed at one side, away from an array substrate, of the reflective polarization structure, so that the reflective polarization structure may be protected, thereby preventing the reflective polarization structure from being corroded by an external environment.

During specific implementation, for example, the material of the protective layer may include an insulating material.

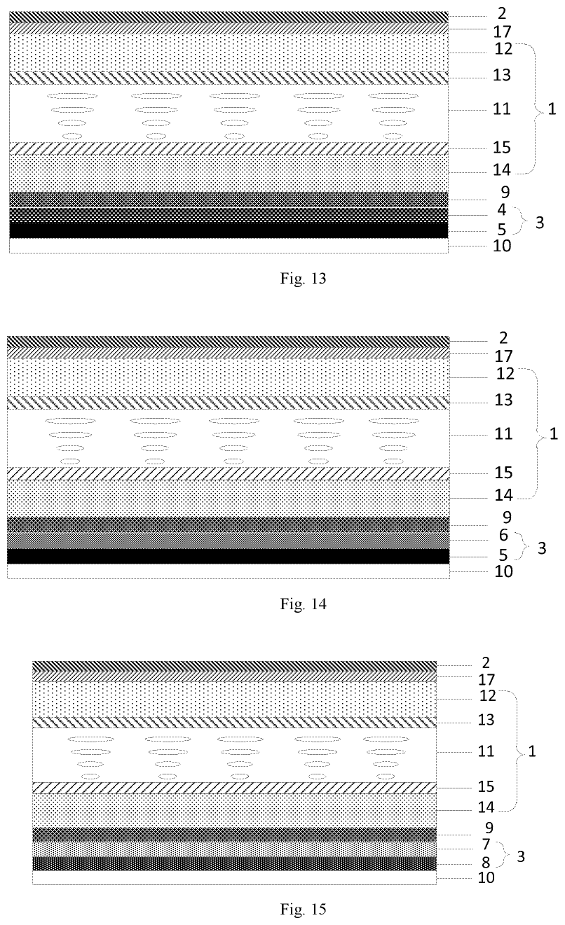

During specific implementation, as shown in FIGS. 13-15, the display device provided in the embodiment of the present disclosure further includes:

a scattering layer 17 arranged between the first polarizer 2 and a first alignment layer 13.

In the display device provided in the embodiment of the present disclosure, the scattering layer is arranged between the first polarizer and the first alignment layer, thereby increasing a visual angle of the display panel.

During specific implementation, for example, the scattering layer may include a scattering film or a hazy film.

During specific implementation, as shown in FIG. 1, FIG. 2, FIG. 4 and FIGS. 6-15, the display device provided in the embodiment of the present disclosure, the liquid crystal cell further includes:

a liquid crystal layer 11;

an opposite substrate 12 arranged at one side, facing the first polarizer 2, of the liquid crystal layer 11, where the opposite substrate 12 includes a first alignment layer 13 adjacent to the liquid crystal layer 11, and a rubbing alignment direction of the first alignment layer 13 is parallel to a transmission axis of the first polarizer 2; and

an array substrate 14 arranged at one side, facing the reflective polarization structure 3, of the liquid crystal layer 11; where the array substrate 14 includes a second alignment layer 15 adjacent to the liquid crystal layer 11, and a rubbing alignment direction of the second alignment layer 15 is perpendicular to the transmission axis of the first polarizer 2.

In the display device provided in the embodiment of the present disclosure, the liquid crystal cell may be a twisted nematic (TN) liquid crystal cell.

Exemplarily, with the liquid crystal cell in the display device further provided in the embodiment of the present disclosure being the TN liquid crystal cell, a working principle of the display device provided in the embodiment of the present disclosure is illustrated below.

During specific implementation, for the reflective polarization structures provided in Mode 1 and Mode 2, an angle of the transmission axis of the first polarizer and an alignment angle of the first alignment layer are 0°, an alignment angle of the second alignment layer is 90°, an angle of the transmission axis of the reflective light brightness enhance film or polarization apparatus is 0°, and an angle of the reflection axis of the reflective light brightness enhance film or polarization apparatus is 90°.

When no voltage is applied to the liquid crystal cell, a liquid crystal is subjected to twisted alignment at 90° under the action of an alignment film, natural light becomes linearly polarized light having a polarization direction of 0° after passing through the first polarizer, the linearly polarized light of 0° becomes linearly polarized light of 90° after passing through the liquid crystal cell, and a polarization direction of the linearly polarized light of 90° is parallel to the reflection axis of the reflective light brightness enhance film or the polarization apparatus. Therefore the linearly polarized light of 90° is reflected after reaching the reflective light brightness enhance film or the polarization apparatus, and reflected light becomes linearly polarized light of 0° after passing through the liquid crystal cell, so as to be emitted from the first polarizer. In this case, the display panel is in a bright state, that is, displaying of a gray scale value 255 is realized.

When a dark-state working voltage is applied to the liquid crystal cell, the liquid crystal is arranged vertically, the natural light becomes linearly polarized light having a polarization direction of 0° after passing through the first polarizer, the linearly polarized light of 0° is still the linearly polarized light of 0° after passing through the liquid crystal cell, and the polarization direction of the linearly polarized light of 0° is parallel to the transmission axis of the reflective light brightness enhance film or polarization apparatus; so that the linearly polarized light of 0° may be absorbed by the light absorption layer after passing through the reflective light brightness enhance film or the polarization apparatus. Thus, dark-state display is realized, that is, displaying of a gray scale value 0 is realized.

For a gray scale with the value between values 0-255, a voltage corresponding to a gray scale to be displayed is applied to the liquid crystal cell, natural light becomes elliptically polarized light after passing through the first polarizer and the liquid crystal cell, after the elliptically polarized light reaches the reflective light brightness enhance film or the polarization apparatus, a part of the elliptically polarized light is reflected by the reflective light brightness enhance film or the polarization apparatus, the other part of the elliptically polarized light is transmitted by the reflective light brightness enhance film or polarization apparatus and then absorbed by the light absorption layer, and a gray scale state corresponding to the applied voltage is displayed.

During specific implementation, for the reflective polarization structure provided in Mode 3, an angle of the transmission axis of the first polarizer and an alignment angle of the first alignment layer are 0°, and an angle of the transmission axis of the second polarizer and an alignment angle of the second alignment layer are 90°.

When no voltage is applied to the liquid crystal cell, the liquid crystal is subjected to twisted alignment at 90° under the action of an alignment film, the natural light becomes linearly polarized light having a polarization direction of 0° after passing through the first polarizer, the linearly polarized light of 0° becomes linearly polarized light of 90° after passing through the liquid crystal cell, a polarization direction of the linearly polarized light of 90° is parallel to the transmission axis of the second polarizer, the linearly polarized light of 90° may be reflected by the reflective layer after passing through the second polarizer, and reflected light becomes linearly polarized light of 0° after passing through the liquid crystal cell, so as to be emitted from the first polarizer. In this case, the display panel is in a bright state, that is, displaying of a gray scale value 255 is realized.

When a dark-state working voltage is applied to the liquid crystal cell, the liquid crystal is arranged vertically, the natural light becomes linearly polarized light having a polarization direction of 0° after passing through the first polarizer, the linearly polarized light of 0° is still the linearly polarized light of 0° after passing through the liquid crystal cell, the polarization direction of the linearly polarized light of 0° is perpendicular to the transmission axis of the second polarizer, and the linearly polarized light of 0° is absorbed after reaching the second polarizer. Thus, dark-state display is realized, that is, displaying of a gray scale value 0 is realized.

For a gray scale with the value between values 0-255, a voltage corresponding to the gray scale to be displayed is applied to the liquid crystal cell, natural light becomes elliptically polarized light after passing through the first polarizer and the liquid crystal cell, after the elliptically polarized light reaches the second polarizer, a part of the elliptically polarized light is absorbed by the second polarizer, the other part of the elliptically polarized light is transmitted by the second polarizer and then reflected by the reflective layer, and a gray scale state corresponding to the applied voltage is displayed.

During specific implementation, in the display device provided in the embodiment of the present disclosure, the liquid crystal cell also may be an in-plane switching (IPS) liquid crystal cell, a vertical alignment (VA) liquid crystal cell, and an advanced super dimension switch (ADS) liquid crystal cell. As shown in FIG. 1, FIG. 2, FIG. 4 and FIGS. 6-15, the liquid crystal cell includes:

a liquid crystal layer 11;

an opposite substrate 12 arranged at one side, facing the first polarizer 2, of the liquid crystal layer 11; where the opposite substrate 12 includes a first alignment layer 13 adjacent to the liquid crystal layer 11, and a rubbing alignment direction of the first alignment layer 13 is parallel to a transmission axis of the first polarizer 2; and

an array substrate 14 arranged at one side, facing the reflective polarization structure 3, of the liquid crystal layer 11; where the array substrate 14 includes: a second alignment layer 15 adjacent to the liquid crystal layer 11, and a rubbing alignment direction of the second alignment layer 15 is parallel to the transmission axis of the first polarizer 2.

Exemplarily, with the liquid crystal cell in the display device provided in the embodiment of the present disclosure being one of the ADS liquid crystal cell, the IPS liquid crystal cell and the VA liquid crystal cell, a working principle of the display device provided in the embodiment of the present disclosure is illustrated below.

During specific implementation, for the reflective polarization structures provided in Mode 1 and Mode 2, an angle of a transmission axis of a first polarizer and an alignment angle of the first alignment layer are 0°, an angle of a transmission axis of a reflective light brightness enhance film or the polarization apparatus and an alignment angle of a second alignment layer are 0°, and an angle of a reflection axis of the reflective light brightness enhance film or the polarization apparatus is 90°.

When no voltage is applied to the liquid crystal cell, natural light becomes linearly polarized light having a polarization direction of 0° after passing through the first polarizer, the linearly polarized light of 0° is still the linearly polarized light of 0° after passing through the liquid crystal cell, and the linearly polarized light of 0° may be absorbed by a light absorption layer after passing through the reflective light brightness enhance film or the polarization apparatus. Thus, dark-state display is realized, that is, displaying of a gray scale value 0 is realized.

When a bright-state working voltage is applied to the liquid crystal cell, a liquid crystal rotates, the natural light becomes linearly polarized light having a polarization direction of 0° after passing through the first polarizer, the linearly polarized light of 0° becomes linearly polarized light of 90° after passing through the liquid crystal cell, and a polarization direction of the linearly polarized light of 90° is parallel to the reflection axis of the reflective light brightness enhance film or polarization apparatus, so that the linearly polarized light of 90° is reflected after reaching the reflective light brightness enhance film or the polarization apparatus, and reflected light becomes linearly polarized light of 0° after passing through the liquid crystal cell, so as to be emitted from the first polarizer. In this case, the display panel is in a bright state, that is, displaying of a gray scale value 255 is realized.

For a gray scale with the value between values 0-255, a voltage responding to a gray scale to be displayed is applied to the liquid crystal cell, the natural light becomes elliptically polarized light after passing through the first polarizer and the liquid crystal cell, after the elliptically polarized light reaches the reflective light brightness enhance film or the polarization apparatus, a part of the elliptically polarized light is reflected by the reflective light brightness enhance film or the polarization apparatus, the other part of the elliptically polarized light is transmitted by the reflective light brightness enhance film or the polarization apparatus and then absorbed by the light absorption layer, and a gray scale state corresponding to the applied voltage is displayed.

During specific implementation, for the reflective polarization structure provided in Mode 3, an angle of the transmission axis of the first polarizer and the alignment angle of the first alignment layer are 0°, the alignment angle of the second alignment layer is 0°, and an angle of the transmission axis of the second polarizer is 90°.

When no voltage is applied to the liquid crystal cell, the natural light becomes linearly polarized light having a polarization direction of 0° after passing through the first polarizer, the linearly polarized light of 0° is still the linearly polarized light of 0° after passing through the liquid crystal cell, the polarization direction of the linearly polarized light of 0° is perpendicular to the transmission axis of the second polarizer, and the linearly polarized light of 0° is absorbed by the second polarizer. Thus, dark-state display is realized, that is, displaying of a gray scale value 0 is realized.

When a bright-state working voltage is applied to the liquid crystal cell, the natural light becomes linearly polarized light having a polarization direction of 0° after passing through the first polarizer, the linearly polarized light of 0° becomes linearly polarized light of 90° after passing through the liquid crystal cell, and a polarization direction of the linearly polarized light of 90° is parallel to the transmission axis of the second polarizer, so that the linearly polarized light of 90° may be reflected by a reflective layer after passing through the second polarizer, and reflected light becomes linearly polarized light of 0° after passing through the liquid crystal cell, so as to be emitted from the first polarizer. In this case, a display panel is in a bright state, that is, displaying of a gray scale value 255 is realized.

For a gray scale with the value between values 0-255, a voltage responding to the gray scale to be displayed is applied to the liquid crystal cell, the natural light becomes elliptically polarized light after passing through the first polarizer and the liquid crystal cell, after the elliptically polarized light reaches the second polarizer, a part of the elliptically polarized light is absorbed by the second polarizer, the other part of the elliptically polarized light is transmitted by the second polarizer and then reflected by the reflective layer, and a gray scale state corresponding to the applied voltage is displayed.

In the display device provided in the embodiment of the present disclosure, for example, the array substrate may further include a glass substrate and a thin film transistor pixel circuit formed on the glass substrate. The thin film transistor pixel circuit includes, for example, a gate line, a data line, a thin film transistor, a pixel electrode, etc. For example, the opposite substrate may further include a color resistance, a black matrix, a spacer, etc. A common electrode may be arranged in the array substrate or the opposite substrate.

It should be noted that a reflective liquid crystal cell is conventionally designed by forming a pattern of a reflective layer in a sub-pixel area of the array substrate. In this way, when the array substrate is manufactured, it is necessary to add a set of mask to conduct a patterning process of the reflective layer. Considering accuracy of the process and apparatus, the reflective layer needs to have a certain distance from the gate line and the data line of the array substrate. When there is alignment deviation of the reflective layer, a scanning signal or a data signal is likely to affect the pixel electrode making direct contact with the reflective layer under alignment fluctuation, resulting in crosstalk-like poor display.

In the display device provided in the embodiment of the present disclosure, the reflective polarization structure is arranged on one side, away from the liquid crystal layer, of the array substrate; that is, the reflective polarization structure is arranged outside the liquid crystal cell, so that the reflective polarization structure does not need to be patterned, a manufacturing process flow of the display device may be simplified, there is no need to consider alignment accuracy of the reflective polarization structure, and manufacturing process difficulty of the display device is lowered; moreover, the reflective polarization structure cannot make contact with the pixel electrode in the array substrate outside the liquid crystal cell; and in actual application, influence of the scanning signal and the data signal on the pixel electrode due to the reflective polarization structure is prevented. Furthermore, in the display device provided in the embodiment of the present disclosure, the reflective polarization structure is manufactured outside the liquid crystal cell, and a design structure in the liquid crystal cell may adopt a design mode of a conventional transmissive liquid crystal display cell. In actual application, a complete transmissive liquid crystal cell may be manufactured first, and then the reflective polarization structure may be arranged on one side, away from the liquid crystal layer, of the array substrate. Therefore, after a sample of the liquid crystal cell is manufactured, a cell gap of the liquid crystal cell may be measured, after characterization, appropriate design specifications of a liquid crystal amount and a height of the spacer may be defined, and then same design parameters may be applied to manufacturing of a reflective display device.

The display device provided in the embodiment of the present disclosure may be applied to any product or component with a display function, such as a mobile phone, a tablet computer, a television, a display screen, a notebook computer, a digital photo frame and a navigator.

Exemplarily, with the liquid crystal cell being a TN liquid crystal cell, the display device provided in the embodiment of the present disclosure and the display device provided in the prior art are simulated. The display device a includes a reflective light brightness enhance film and a light absorption layer, that is, the display device a is the display device provided in the embodiment of the present disclosure, and related parameters of the display device a are shown in Table 1.

TABLE 1

| | |
|---|---|
| Angle of transmission axis of first polarizer | 0° |
| Cell gap | 4 μm |
| Rubbing alignment angle of first alignment layer | 0° |
| Initial alignment angle of liquid crystal | 90° |
| Rubbing alignment angle of second alignment layer | 90° |
| Angle of transmission axis of reflective light brightness enhance | 90° |
| film | |

The display device b is a traditional reflective display device provided in the prior art, one side of an opposite substrate of the display device b includes an upper polarizer, a half-wave plate and a quarter-wave plate; one side, away from the opposite substrate, of the liquid crystal is provided with a reflective layer; and related parameters of the display device b are as shown in Table 2.

TABLE 2

| | |
|---|---|
| Angle of transmission axis of first polarizer | 80° |
| Angle of transmission axis of half-wave plate | 62.5° |
| Compensation value of half-wave plate | 270 nm |
| Angle of transmission axis of quarter-wave plate | 0° |
| Compensation value of quarter-wave plate | 160 nm |
| Cell gap | 2.7 μm |
| Rubbing alignment angle of first alignment layer | 55° |
| Initial alignment angle of liquid crystal | 60° |
| Rubbing alignment angle of second alignment layer | 115° |

During specific implementation, Techwiz optical software may be used to simulate display panel a and display panel b, and to simulate results of a full-wave range from 380 nm to 780 nm of a wavelength of light. Simulation results are as follows.

(1) Contrast of the display device a is 573.0, and contrast of the display device b is 52.5.

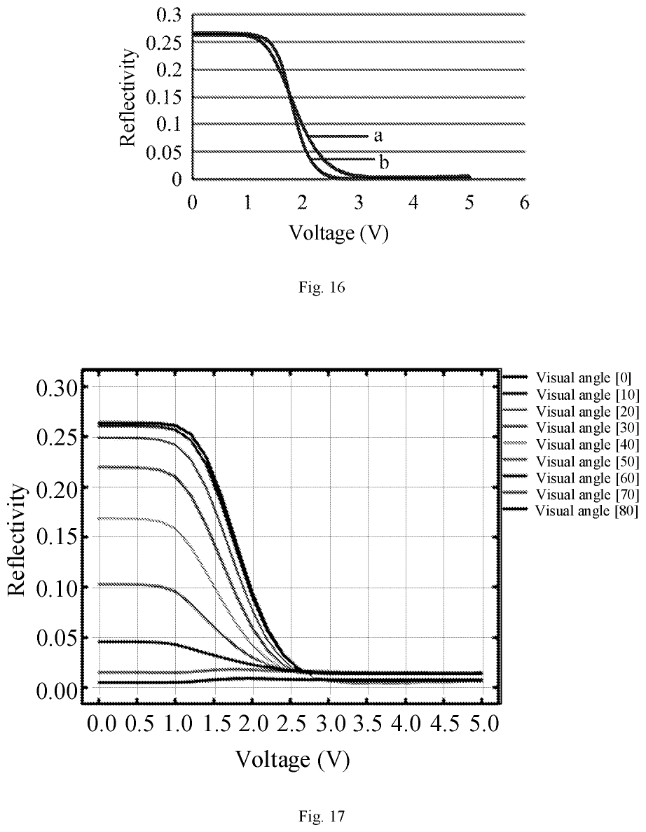

(2) Simulation results of voltage-reflectivity are as shown in FIG. 16, a reflectivity of the display device a is 26.6%, a reflectivity of the display device b is 26.4%, the reflectivity of the display device a is equivalent to that of the display device b, and the contrast of the display device a is 10 times or more higher than that of the display device b. Moreover, a working voltage Vop of the display device a is also reduced, a working voltage Vop of the display device b is about 4.2 V, and a working voltage Vop of the display device a is about 3.5 V, so power consumption of the display device provided in the embodiment of the present disclosure may be greatly reduced.

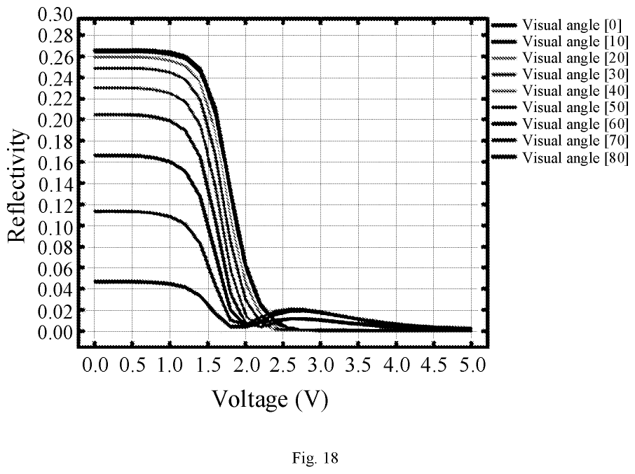

(3) Simulation results of voltage-reflectivity of different visual angles of the display device a are shown in FIG. 17, and simulation results of voltage-reflectivity of different visual angles of the display device b are shown in FIG. 18. According to actual results, it may be concluded that a visual angle of the display device a is larger.

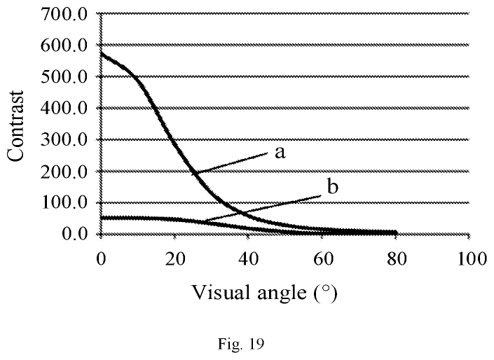

(4) Simulation results of attenuation of visual angles of the display device a and the display device b are as shown in FIG. 19. Although the display device a attenuates obviously with the visual angle, contrast of any visual angle of the display device a is still higher than that of the display device b because of a higher basic value of a main visual angle of the display device a.

Based on the same inventive concept, an embodiment of the present disclosure further provides a driving method for the display device. As shown in FIG. 20, the driving method includes the following.

S101, a liquid crystal in a liquid crystal cell is controlled to be in a first state to change a polarization state of light passing through a first polarizer after the light passes through the liquid crystal cell, then the light is reflected by a reflective polarization structure, the polarization state of reflected light is changed again after the reflected light passes through the liquid crystal cell, and the reflected light is emitted from the first polarizer, to realize bright-state display.

S102, the liquid crystal in the liquid crystal cell is controlled to be in a second state to change the polarization state of the light passing through the first polarizer after the light passes through the liquid crystal cell, and then the light is absorbed by the reflective polarization structure, to realize dark-state display.

S103, the liquid crystal in the liquid crystal cell is controlled to be in a third state to change a polarization state of part of light passing through the first polarizer and unchange a polarization state of the remaining part of light after the light passes through the liquid crystal cell, then the part of light is absorbed by the reflective polarization structure, the remaining part of light is reflected by the reflective polarization structure, the polarization state of reflected light is changed again after the reflected light passes through the liquid crystal cell, and the reflected light is emitted from the first polarizer, to realize gray scale display between the bright-state display and the dark-state display.

According to the driving method for the display device provided in the embodiment of the present disclosure, a state of the liquid crystal in the liquid crystal cell is changed to change phase difference of light, so that the light is absorbed or reflected by the reflective polarization structure. Without arranging a half-wave plate and a quarter-wave plate between the liquid crystal cell and the first polarizer to change the phase difference, a reflective display function may be realized, contrast of a display frame may be improved, light leakage in a low gray scale may be avoided, a display effect may be improved, and user experience may be enhanced.

During specific implementation, for a display device including a TN liquid crystal cell, in the driving method for the display device provided in the embodiment of the present disclosure, a rubbing alignment direction of a first alignment layer is parallel to the transmission axis of the first polarizer, and a rubbing alignment direction of a second alignment layer is perpendicular to the transmission axis of the first polarizer. The step S101 that the liquid crystal in the liquid crystal cell is controlled to be in the first state specifically includes: applying no voltage to the liquid crystal cell, and controlling the liquid crystal in the liquid crystal cell to be in an initial alignment state; the step S102 that the liquid crystal in the liquid crystal cell is controlled to be in the second state specifically includes: applying a bright-state voltage to the liquid crystal cell, and controlling the liquid crystal in the liquid crystal cell to deflect to the second state; and the step S103 that the liquid crystal in the liquid crystal cell is controlled to be in the third state specifically includes: applying a preset voltage corresponding to a gray-scale value to the liquid crystal cell, and controlling the liquid crystal in the liquid crystal cell to deflect to the third state.

During specific implementation, the display device includes one of an ADS liquid crystal cell, an IPS liquid crystal cell or a VA liquid crystal cell; a rubbing alignment direction of a first alignment layer is parallel to the transmission axis of the first polarizer, and a rubbing alignment direction of a second alignment layer is parallel to the transmission axis of the first polarizer. The step S101 that the liquid crystal in the liquid crystal cell is controlled to be in the first state specifically includes: applying a dark-state voltage to the liquid crystal cell, and controlling the liquid crystal in the liquid crystal cell to deflect to the first state; the step S102 that the liquid crystal in the liquid crystal cell is controlled to be in the second state specifically includes: applying no voltage to the liquid crystal cell, and controlling the liquid crystal in the liquid crystal cell to deflect to an initial alignment state; and the step S103 that the liquid crystal in the liquid crystal cell is controlled to be in the third state specifically includes: applying a preset voltage corresponding to a gray-scale value to the liquid crystal cell, and controlling the liquid crystal in the liquid crystal cell to deflect to the third state.

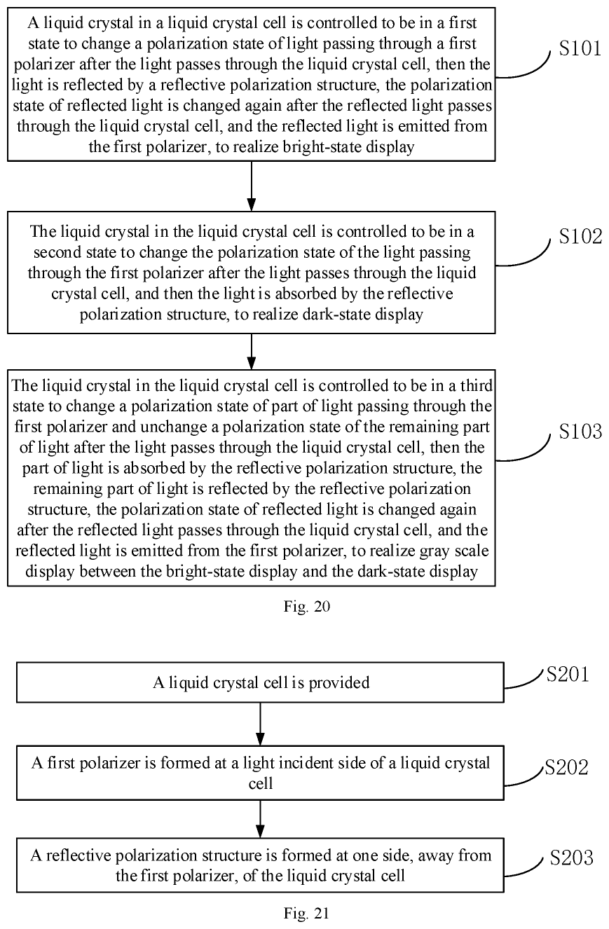

Based on the same inventive concept, an embodiment of the present disclosure further provides a manufacturing method of the display device. As shown in FIG. 21, the manufacturing method includes the following.

S201, a liquid crystal cell is provided.

S202, a first polarizer is formed at a light incident side of a liquid crystal.

S203, a reflective polarization structure is formed at one side, away from the first polarizer, of the liquid crystal cell.

According to the manufacturing method of the display device provided in the embodiment of the present disclosure, the reflective polarization structure is formed at one side, away from the first polarizer, of the liquid crystal cell. Without arranging a half-wave plate and a quarter-wave plate at one side, facing the first polarizer, of the liquid crystal cell to change phase difference, contrast of a display frame may be improved, light leakage in a low gray scale may be avoided, a display effect may be improved, and user experience may be enhanced. Moreover, the reflective polarization structure is arranged outside the liquid crystal cell, so that the reflective polarization structure does not need to be patterned, and a manufacturing process flow of the display device may be simplified. In addition, the reflective polarization structure is arranged outside the liquid crystal cell, so after a sample of the liquid crystal cell is manufactured, a cell gap of the liquid crystal cell may be measured.

During specific implementation, in the manufacturing method of the display device provided in the embodiment of the present disclosure, the step S202 that the reflective polarization structure is formed at one side, away from the first polarizer, of the liquid crystal cell specifically includes the following:

S2021, a reflective light brightness enhance film is formed at an entire face of one side, away from the first polarizer, of the liquid crystal cell; and

S2022, a light absorption layer is formed at an entire face of one side, away from the liquid crystal cell, of the reflective light brightness enhance film.

Or, during specific implementation, in the manufacturing method of the display device provided in the embodiment of the present disclosure, the step S202 that the reflective polarization structure is formed at one side, away from the first polarizer, of the liquid crystal cell specifically includes the following:

S2021, a polarization apparatus is formed at an entire face of one side, away from the first polarizer, of the liquid crystal cell; and

S2022, a light absorption layer is formed at an entire face of one side, away from the liquid crystal cell, of the polarization apparatus.

Or, during specific implementation, in the manufacturing method of the display device provided in the embodiment of the present disclosure, the step S202 that the reflective polarization structure is formed at one side, away from the first polarizer, of the liquid crystal cell specifically includes the following: S2021, a second polarizer is formed at an entire face of one side, away from the first polarizer, of the liquid crystal cell; and

S2022, a reflective layer is formed at an entire face of one side, away from the liquid crystal cell, of the second polarizer.

During specific implementation, for example, the material of the reflective layer may be metal, and a metal material may be evaporated on one side, away from the liquid crystal cell, of the second polarizer as the reflective layer through an evaporation process.

During specific implementation, in the manufacturing method of the display device provided in the embodiment of the present disclosure, the manufacturing method further includes: forming a protective layer at one side, away from the liquid crystal cell, of the reflective polarization structure.

During specific implementation, for example, an insulating material may be evaporated on one side, away from the liquid crystal cell, of the reflective polarization structure as the protective layer through an evaporation process.

During specific implementation, in the manufacturing method of the display device provided in the embodiment of the present disclosure, the manufacturing method further includes: forming an antireflective layer between the reflective polarization structure and the liquid crystal.

During specific implementation, the antireflective layer may be manufactured through a vacuum film forming method such as vapor deposition or sputtering, or a wet type film forming method such as dip coating or spin coating.

During specific implementation, in the manufacturing method of the display device provided in the embodiment of the present disclosure, the manufacturing method further includes: forming a scattering layer between the liquid crystal cell and the first polarizer.

During specific implementation, in the manufacturing method of the display device provided in the embodiment of the present disclosure, the step S101 that a liquid crystal cell is provided specifically includes: providing an array substrate and an opposite substrate; and aligning the array substrate and the opposite substrate through a box aligning process, and filling a space between the array substrate and the opposite substrate with a liquid crystal.

During specific implementation, the step that an opposite substrate is provided includes the following steps that a first alignment layer is formed and rubbing alignment are conducted on the first alignment layer, and the step that an array substrate is provided includes the following steps that a second alignment layer is formed and rubbing alignment are conducted on the second alignment layer.

During specific implementation, for a TN liquid crystal cell, a rubbing alignment direction of the first alignment layer is parallel to the transmission axis of the first polarizer, and a rubbing alignment direction of the second alignment layer is perpendicular to the transmission axis of the first polarizer.

During specific implementation, for an ADS liquid crystal cell, an IPS liquid crystal cell or a VA liquid crystal cell, a rubbing alignment direction of the first alignment layer is parallel to the transmission axis of the first polarizer, and a rubbing alignment direction of the second alignment layer is parallel to the transmission axis of the first polarizer.

According to the display device and the driving method therefor and the manufacturing method thereof provided in the embodiments of the present disclosure, in the display device, one side, away from the first polarizer, of the liquid crystal cell is provided with the reflective polarization structure; the reflective polarization structure may absorb the light having the polarization direction parallel to the direction of the transmission axis of the first polarizer, and reflect the light having the polarization direction perpendicular to the direction of the transmission axis of the first polarizer; and further a state of a liquid crystal in the liquid crystal cell is changed to change phase difference of light, so that the light is absorbed or reflected by the reflective polarization structure. Without arranging the half-wave plate and the quarter-wave plate between the liquid crystal cell and the first polarizer to change the phase difference, a reflective display function may be realized, contrast of a display frame may be improved, light leakage in a low gray scale may be avoided, a display effect may be improved, and user experience may be enhanced.

Although the preferred embodiments of the present disclosure have been described, those skilled in the art can make additional alterations and modifications to these embodiments once they learn the basic inventive concept. Therefore, the appended claims are intended to be interpreted as including the preferred embodiments and all alterations and modifications falling within the scope of the present disclosure.

Apparently, those skilled in the art may make various modifications and variations to the embodiments of the present disclosure without departing from the spirit and scope of the embodiments of the present disclosure. In this way, if these modifications and variations of the embodiments of the present disclosure fall within the scope of the claims of the present disclosure and their equivalent technologies, the present disclosure is also intended to include these modifications and variations.

1. A display device, comprising:
a liquid crystal cell;
a first polarizer arranged at a light incident side of the liquid crystal cell; and
a reflective polarization structure arranged at one side, away from the first polarizer, of the liquid crystal cell;
wherein the reflective polarization structure is configured to:
absorb light having a polarization direction parallel to a direction of a transmission axis of the first polarizer, and
reflect light having a polarization direction perpendicular to the direction of the transmission axis of the first polarizer.

2. The display device according to claim 1, wherein the reflective polarization structure comprises:
a reflective light brightness enhance film, wherein a transmission axis of the reflective light brightness enhance film is parallel to the transmission axis of the first polarizer, and a reflection axis of the reflective light brightness enhance film is perpendicular to the transmission axis of the first polarizer; and
a light absorption layer arranged at one side, away from the liquid crystal cell, of the reflective light brightness enhance film.

3. The display device according to claim 1, wherein the reflective polarization structure comprises:
a polarization apparatus comprising a plurality of stacked wave plates, wherein a transmission axis of the polarization apparatus is parallel to the transmission axis of the first polarizer, and a reflection axis of the polarization apparatus is perpendicular to the transmission axis of the first polarizer; and
a light absorption layer arranged at one side, away from the liquid crystal cell, of the polarization apparatus.

4. The display device according to claim 1, wherein the reflective polarization structure comprises:
a second polarizer, wherein a transmission axis of the second polarizer is perpendicular to the transmission axis of the first polarizer; and
a reflective layer arranged at one side, away from the liquid crystal cell, of the second polarizer.

5. The display device according to claim 1, further comprising:
an antireflective layer arranged between the reflective polarization structure and the liquid crystal cell.

6. The display device according to claim 1, further comprising:
a protective layer arranged at one side, away from the liquid crystal cell, of the reflective polarization structure.

7. The display device according to claim 1, further comprising:
a scattering layer arranged between the first polarizer and the liquid crystal cell.

8. The display device according to claim 1, wherein the liquid crystal cell comprises:
a liquid crystal layer;
an opposite substrate arranged at one side, facing the first polarizer, of the liquid crystal layer; wherein the opposite substrate comprises a first alignment layer adjacent to the liquid crystal layer, and a rubbing alignment direction of the first alignment layer is parallel to the transmission axis of the first polarizer; and
an array substrate arranged at one side, facing the reflective polarization structure, of the liquid crystal layer; wherein the array substrate comprises a second alignment layer adjacent to the liquid crystal layer, and a rubbing alignment direction of the second alignment layer is perpendicular to the transmission axis of the first polarizer.

9. The display device according to claim 1, wherein the liquid crystal cell comprises:
a liquid crystal layer;
an opposite substrate arranged at one side, facing the first polarizer, of the liquid crystal layer, wherein the opposite substrate comprises a first alignment layer adjacent to the liquid crystal layer, and a rubbing alignment direction of the first alignment layer is parallel to the transmission axis of the first polarizer; and
an array substrate arranged at one side, facing the reflective polarization structure, of the liquid crystal layer, wherein the array substrate comprises a second alignment layer adjacent to the liquid crystal layer, and a rubbing alignment direction of the second alignment layer is parallel to the transmission axis of the first polarizer.

10. A driving method for the display device according to claim 1, comprising:
controlling a liquid crystal in the liquid crystal cell to be in a first state for changing a polarization state of light passing through the first polarizer after the light passes through the liquid crystal cell, reflecting the light by the reflective polarization structure, changing the polarization state of reflected light again after the reflected light passes through the liquid crystal cell, and emitting the reflected light from the first polarizer, for realizing bright-state display;
controlling the liquid crystal in the liquid crystal cell to be in a second state for changing a polarization state of light passing through the first polarizer after the light passes through the liquid crystal cell, and absorbing the light by the reflective polarization structure, for realizing dark-state display; and
controlling the liquid crystal in the liquid crystal cell to be in a third state for changing a polarization state of part of light passing through the first polarizer and unchange a polarization state of remaining part of light after the light passes through the liquid crystal cell, absorbing the part of light by the reflective polarization structure, and reflecting the remaining part of light by the reflective polarization structure, changing the polarization state of reflected light again after the reflected light passes through the liquid crystal cell, and emitting the reflected light from the first polarizer, for realizing gray scale display between the bright-state display and the dark-state display.

11. The driving method for the display device according to claim 10, wherein a rubbing alignment direction of a first alignment layer is parallel to the transmission axis of the first polarizer, and a rubbing alignment direction of a second alignment layer is perpendicular to the transmission axis of the first polarizer;
wherein the controlling the liquid crystal in the liquid crystal cell to be in the first state specifically comprises:
applying no voltage to the liquid crystal cell, and controlling the liquid crystal in the liquid crystal cell to be in an initial alignment state;
wherein the controlling the liquid crystal in the liquid crystal cell to be in the second state specifically comprises:
applying a bright-state voltage to the liquid crystal cell, and controlling the liquid crystal in the liquid crystal cell to deflect to the second state;
wherein the controlling the liquid crystal in the liquid crystal cell to be in the third state specifically comprises:
applying a preset voltage corresponding to a gray-scale value to the liquid crystal cell, and controlling the liquid crystal in the liquid crystal cell to deflect to the third state.

12. The driving method for the display device according to claim 10, wherein a rubbing alignment direction of a first alignment layer is parallel to the transmission axis of the first polarizer, and a rubbing alignment direction of a second alignment layer is parallel to the transmission axis of the first polarizer;
wherein the controlling the liquid crystal in the liquid crystal cell to be in the first state specifically comprises:
applying a dark-state voltage to the liquid crystal cell, and controlling the liquid crystal in the liquid crystal cell to deflect to the first state;
wherein the controlling the liquid crystal in the liquid crystal cell to be in the second state specifically comprises:
applying no voltage to the liquid crystal cell, and controlling the liquid crystal in the liquid crystal cell to deflect to an initial alignment state;
wherein the controlling the liquid crystal in the liquid crystal cell to be in the third state specifically comprises:
applying a preset voltage corresponding to a gray-scale value to the liquid crystal cell, and controlling the liquid crystal in the liquid crystal cell to deflect to the third state.

13. A manufacturing method of the display device according to claim 1, comprising:
providing the liquid crystal cell;
forming the first polarizer at the light incident side of the liquid crystal; and
forming the reflective polarization structure at one side, away from the first polarizer, of the liquid crystal cell.

14. The manufacturing method of the display device according to claim 13, wherein the forming the reflective polarization structure at one side, away from the first polarizer, of the liquid crystal cell specifically comprises:
forming a reflective light brightness enhance film at an entire face of one side, away from the first polarizer, of the liquid crystal cell; and
forming a light absorption layer at an entire face of one side, away from the liquid crystal cell, of the reflective light brightness enhance film.

15. The manufacturing method of the display device according to claim 13, wherein the forming the reflective polarization structure at one side, away from the first polarizer, of the liquid crystal cell specifically comprises:
forming a polarization apparatus at an entire face of one side, away from the first polarizer, of the liquid crystal cell; and
forming a light absorption layer at an entire face of one side, away from the liquid crystal cell, of the polarization apparatus.

16. The manufacturing method of the display device according to claim 13, wherein the forming the reflective polarization structure at one side, away from the first polarizer, of the liquid crystal cell specifically comprises:
forming a second polarizer at an entire face of one side, away from the first polarizer, of the liquid crystal cell; and
forming a reflective layer at an entire face of one side, away from the liquid crystal cell, of the second polarizer.

17. The manufacturing method of the display device according to claim 13, further comprising:
forming a protective layer at one side, away from the liquid crystal cell, of the reflective polarization structure.

18. The manufacturing method of the display device according to claim 13, further comprising:
forming an antireflective layer between the reflective polarization structure and the liquid crystal cell.
